(19) United States
(12) Patent Application Publication
(10) Pub. No.: US 2026/0304206 A1
(43) Pub. Date: Oct. 1, 2026

(54) NETWORK NODE AND A METHOD IN A WIRELESS COMMUNICATIONS NETWORK

(71) Applicant: Telefonaktiebolaget LM Ericsson (publ), Stockholm (SE)

(72) Inventors: Håkan ÖSTERLUND, Ekerö (SE); Mikael KLEIN, Huddinge (SE)

(21) Appl. No.: 19/478,514

(22) PCT Filed: Apr. 25, 2024
(86) PCT No.: PCT/SE2024/050400

§ 371 Date: Oct. 24, 2025

Related U.S. Application Data
(60) Provisional application No. 63/498,272, filed on Apr. 26, 2023.

(51) Int. Cl. H04W 28/02; H04L 12/14; H04W 80/04

(52) U.S. Cl. CPC H04W 28/0252; H04L 12/1407; H04W 80/04

(57) ABSTRACT

A method performed by a network node for managing an Internet Protocol, IP, flow in a User Plane, UP, session to be boosted on request by an Application Function, AF, node for a User Equipment, UE, in a wireless communications network is provided The network node obtains (201) from a first Core Network, CN, node, information identifying UP sessions that are available to the UE, based on a subscriber identifier of a user of the UE. The network node determines (202), based on configuration data received from a second CN node, whether boost is allowed for a particular UP session among the identified UP sessions. When it is determined that boost is allowed in the particular UP session, the network node determines (203) a source IP address for the particular UP session. The network node requests (204) from the second CN node, boost of the IP flow identified by the source IP address as determined, and a destination IP address and port comprised in information obtained from the AF node. The network node configures (205) in the second CN node, a Policy and Charging Control, PCC, rule to the identified IP flow for the particular UP session where boost is determined to be allowed.

### TECHNICAL FIELD

Embodiments herein relate to a network node and a method in a wireless communications network. In some aspects they relate to managing an Internet Protocol (IP) flow in a User Plane (UP) session to be boosted on request by an Application Function (AF) node for a User Equipment (UE).

### BACKGROUND

In a typical wireless communication network, wireless devices, also known as wireless communication devices, mobile stations, stations (STA) and/or User Equipment (UE), communicate via a Wide Area Network or a Local Area Network such as a Wi-Fi network or a cellular network comprising a Radio Access Network (RAN) part and a Core Network (CN) part. The RAN covers a geographical area which is divided into service areas or cell areas, which may also be referred to as a beam or a beam group, with each service area or cell area being served by a radio network node such as a radio access node e.g., a Wi-Fi access point, a Base Station (BS) or a radio base station (RBS), which in some networks may also be denoted, for example, a Base Station (BS), a NodeB, eNodeB (eNB), or gNodeB (gNB) as denoted in Fifth Generation (5G) telecommunications. A service area or cell area is a geographical area where radio coverage is provided by the radio network node. The radio network node communicates over an air interface operating on a radio frequency with the wireless devices within the range of the radio network node.

3rd Generation Partnership Project (3GPP) is the standardization body for specifying the standards for the cellular system evolution, e.g., including 3G, 4G, 5G and the future evolutions. Specifications for Evolved Universal Terrestrial Radio Access (E-UTRA) and Evolved Packet System (EPS) have been completed within the 3GPP. In 4G also called a Fourth Generation (4G) network, EPS is core network and E-UTRA is radio access network. In 5G, 5GC is core network, NR is radio access network. As a continued network evolution, the new release of 3GPP specifies a 5G network also referred to as 5G New Radio (NR) and 5G Core (5GC).

Frequency bands for 5G NR are being separated into two different frequency ranges, Frequency Range 1 (FR1) and Frequency Range 2 (FR2). FR1 comprises sub-6 GHz frequency bands. Some of these bands are bands traditionally used by legacy standards but have been extended to cover potential new spectrum offerings from 410 MHz to 7125 MHz. FR2 comprises frequency bands from 24.25 GHz to 52.6 GHz. Bands in this millimeter wave range have shorter range but higher available bandwidth than bands in the FR1.

Multi-antenna techniques may significantly increase the data rates and reliability of a wireless communication system. For a wireless connection between a single user, such as UE, and a base station (BS), the performance is in particular improved if both the transmitter and the receiver are equipped with multiple antennas, which results in a Multiple-Input Multiple-Output (MIMO) communication channel. This may be referred to as Single-User (SU)-MIMO. In the scenario where MIMO techniques is used for the wireless connection between multiple users and the base station, MIMO enables the users to communicate with the base station simultaneously using the same time-frequency resources by spatially separating the users, which increases further the cell capacity. This may be referred to as Multi-User (MU)-MIMO. Note that MU-MIMO may benefit when each UE only has one antenna. The cell capacity can be increased linearly with respect to the number of antennas at the BS side. Due to that, more and more antennas are employed in BS. Such systems and/or related techniques are commonly referred to as massive MIMO.

### Quality of Service (QOS) on Demand

QoS on Demand (QoD), or Network-initiated QoS (NI-QoS), is a method for an Application Function (AF) to request a change in traffic characteristics of an IP session such as within a Protocol Data Unit (PDU) Session and/or a Packet Data Network (PDN) Connection in a mobile network. While typically referring to different architectures of networks, e.g., 4G or 5G, PDU Session and PDN Connection may in the context of the invention refer to a similar type of session and may be used interchangeably. I.e. any features relating to a PDU session may be applicable for a PDN Connection and vice versa.

### SUMMARY

As a part of developing embodiments herein a problem was identified by the inventors and will first be discussed.

A major problem for mobile Applications (app) wanting to boost a connectivity is to learn about its own, by the network assigned, UE source Internet Protocol (IP) address. The source IP address may need to be included in requests to the core network, e.g., an N33 Interface or a T8 interface Application Programming Interface (API) request, when requesting change of QoS for an IP session. A reason why the source IP address is not visible to the UE app is that the Operating System (OS) of the UE, and corresponding vendors of OSs do not expose this via local APIs. The UE app may instead typically only access a public IP address, which normally is not the true source IP address as it is an IP address translated or mapped by for example a carrier Network address translation (NAT) to a public IP address. This makes it impossible to boost a connectivity on request of sessions with said source IP. As used herein connectivity and connection may be used interchangeably.

When an Application Function (AF) wishes to boost an IP session for a user, or an app of a user in a UE, e.g., relating to an UP session such as a PDU session or PDN Connection, there's currently no way for a network, e.g., Communication Service Provider (CSP) network, when using exposure interfaces such as N33 in 5G e.g., using a Network Exposure Function (NEF) and/or T8 in 4G, e.g., using a Service Capability Exposure Function (SCEF), to determine the following:
1. whether a QoS boost is allowed for a user, in particular based on subscriber information,
2. when QoS boost is allowed, and/or which QoS class or classes that are permitted, when QoS classes are applicable,
3. if the user has multiple UP sessions, e.g., PDU sessions or PDN connections, for which UP session e.g., PDU session or PDN connection, shall the QoS boost apply.

If the user has established more than one UP session e.g., PDU session or PDN connection, a mechanism is also needed to determine which session is to be boosted.

An object of embodiments herein is to improve flexibility and performance of handling and IP flow in a UP session.

According to a first aspect, a method performed by a network node for managing an IP flow in a UP session to be boosted on request by an AF node UE in a wireless communications network is provided. The network node obtains from a first CN node, information identifying UP sessions that are available to the UE, based on a subscriber identifier of a user of the UE. The network node determines, based on configuration data received from a second CN node, whether boost is allowed for a particular UP session among the identified UP sessions. When it is determined that boost is allowed in the particular UP session, the network node determines a source IP address for the particular UP session. The network node requests from the second CN node, boost of the IP flow identified by the source IP address as determined, and a destination IP address and port comprised in information obtained from the AF node. The network node configures in the second CN node, a Policy and Charging Control (PCC) rule to the identified IP flow for the particular UP session where boost is determined to be allowed.

According to a second aspect, a network node, configured to manage an IP flow in a UP session to be boosted on request by an AF node for a UE in a wireless communications network is provided.

The network node is configured to:
obtain from a first CN node information identifying UP sessions that are available to the UE, based on a subscriber identifier of a user of the UE,
determine whether boost is allowed for a particular UP session among the identified UP sessions, based on configuration data received from a second CN node,
when it is determined that boost is allowed in the particular UP session, determine a source IP address for the particular UP session,
request from the second CN node, a boost of the IP flow identified by the source IP address as determined, and a destination IP address and port comprised in information obtained from the AF node, and
configure in the second CN node, a PCC rule to the identified IP flow for the particular UP session where boost is determined to be allowed.

Since the PCC rule can be configured, the IP flow for the particular UP session is enabled to be boosted and hence, its QoS can be changed on demand, also with respect to other sessions or flows. Since the correct source IP for the particular UP session can be determined, it is possible to more flexibly boost IP flows when the UE has multiple UP sessions.

In other words, embodiments herein may relates to a method for a network node such as a NEF and/or SCEF client and/or a Network as a Service (NaaS) to identify an IP flow to be boosted on request, e.g., by
Retrieving a list of UP sessions, e.g. PDU sessions or PDN connectivities, available to a particular user and identifying the UP session that can be boosted, and
Identifying an UP session, e.g. PDU session or PDN connection, having a particular IP flow, and verifying that boost is allowed in this PDU Session.

Once the UP session has been identified, the source IP address for the boost request may be determined using existing methods for PDU Session Status Event monitoring, e.g., as described in 3GPP TS 29.508. A target/destination IP address, port and optionally protocol, e.g., of the IP flow to be boosted in the identified UP session, may be supplied by an AF requesting the boost.

Embodiments herein may be applicable for 4G, 5G and future networks, e.g., 6G, but the terminology may be used in terms of 5G. In other words, if not explicitly stated otherwise, features herein may be applicable for 4G or future networks in corresponding terminology or network entities therein. Embodiments herein may relate to procedures define of how to use the N33 interface in 5GC and/or the T8 interface in EPC, as described in 3GPP TS 23.503 and TS 23.682 respectively.

Boost as used herein may be any QoS change and/or Policy and Charging Control (PCC) rule to an IP flow, e.g., User Plane sessions relating to a particular IP address, e.g., source IP address, wherein said boost may improve performance or priority of said IP flow, e.g., packets and/or messages relating to said IP flow.

When used for embodiments herein, the term IP flow may refer to the term IP session and vice versa.

In embodiments herein, the term UP session may mean any of PDU session or PDN connection. The terms may be used interchangeably.

This also means that when PDU session is used herein, this may mean PDN connection/connectivity or UP session. This also means that when PDN connection/connectivity is used, this may mean UP session or PDU session.

In some scenarios or embodiments, the terms PDN or PDU may be mixed, however, this still shall be interpreted as any UP session, and may refer to the same UP session.

Advantages herein may additionally relate to efficiently and flexibly identifying a correct source IP address of an IP flow for which a QoS boost shall apply to, e.g., when a user have multiple UP sessions, e.g. PDU sessions or PDN connectivities. In other words, when used among multiple UP sessions, each UP session may have their own source IP address, and identifying them all or at least a plurality of them cannot be performed, at least not in an efficient manner, without embodiments herein. This allows for boosting IP flows for one or more UP sessions, on demand in a flexible manner, which thereby improves performance for communication in said IP flows and UP sessions.

### BRIEF SUMMARY OF DRAWINGS

Examples of embodiments herein are described in more detail with reference to attached drawings in which:

FIG. 1 illustrates a schematic block diagram illustrating embodiments of a wireless communications network.

FIG. 2 is a flowchart depicting embodiments of a method.

FIG. 3 is a signaling diagram depicting embodiments of a method.

FIG. 4 is a signaling diagram depicting embodiments of a method.

FIG. 5 is a signaling diagram depicting embodiments of a method.

FIG. 6 is a schematic block diagram illustrating embodiments of a pod unit.

FIGS. 7-11 schematically illustrates a communication system in accordance with some embodiments.

### DETAILED DESCRIPTION

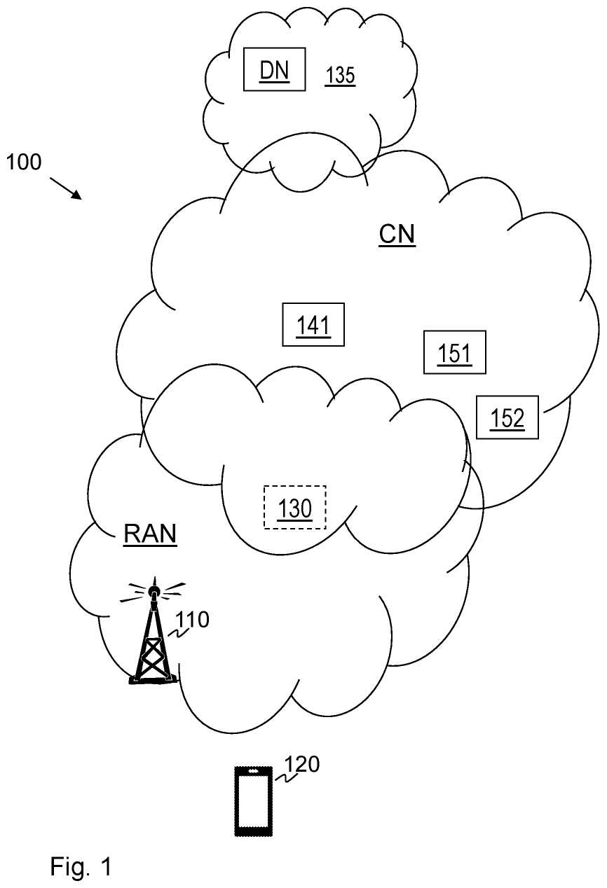

FIG. 1 is a schematic overview depicting a wireless communications network 100, such as e.g. a telecommunications network, wherein embodiments herein may be implemented. The wireless communications network 100 may comprise or be associated with one or more wireless data networks. The communications network 100 comprises one or more RANs and one or more CNs. The communications network 100 may use 5G NR but may further use a number of other different technologies, such as, 6G, Wi-Fi, (LTE), LTE-Advanced, Wideband Code Division Multiple Access (WCDMA), Global System for Mobile communications/enhanced Data rate for GSM Evolution (GSM/EDGE), or Ultra Mobile Broadband (UMB), just to mention a few possible implementations. While the embodiments herein primarily target wireless communications, embodiments herein also apply to wired communications, such as Fixed Wireless Access (FWA). In other words, the wireless communications network 100 may also be a wired communications network or mixed wireless-wired communications network.

Network nodes such as, e.g., a network node 141 may operate in the wireless communications network 100. The network node 141 may be configured to manage one or more respective IP flow in one or more respective UP sessions. The IP flows may be related to a particular UE, e.g., a UE 120. In particular, the network node 141 may be configured to manage one or more respective IP flow in one or more respective UP sessions at least partly by boosting one or more out of the IP flows based on a request, e.g., a QoD request from an AF node 130. The network node 141 may be any suitable network entity, e.g., comprised in a CN or any suitable part of the wireless communications network 100. The network node 141 may be represented by, and/or may comprise any one or more out of a NEF, SCEF, and a NaaS. When NaaS, SCEF, and/or NEF is used herein, a unit performing the corresponding functionality may be implied, e.g., comprised in the network node 141, and/or as part of the network node 141. In some embodiments the network node 141 may comprise a NaaS, e.g., a NaaS unit. Additionally or alternatively, the network node 141 may comprise a NEF or a SCEF. The NaaS and the NEF or SCEF may be located in the same location or co-located. I.e. the network node 141 may in some embodiments be one network node 141, and in some embodiments the network node 141 may be a distributed node comprising the NaaS in one location/node and the NEF or SCEF in one location/node.

UEs, such as the UE 120, operate in the wireless communications network 100. The UE 120 may e.g. be an NR device, a mobile station, a wireless terminal, an IoT device, an IoS device, an enhanced Machine Type Communication (eMTC) device, an NR RedCap device, a CAT-M device, a Vehicle-to-everything (V2X) device, Vehicle-to-Vehicle (V2V) device, a Vehicle-to-Pedestrian (V2P) device, a Vehicle-to-Infrastructure (V2I) device, a Vehicle-to-Network (V2N) device, a Wi-Fi device, an LTE device, a non-access point (non-AP) STA, a STA, that communicates via a base station such as e.g. the network node 110, and one or more Access Networks (AN), e.g. RAN, to one or more core networks (CN). It should be understood by the skilled in the art that the term UE relates to a non-limiting term which means any UE, terminal, wireless communication terminal, user equipment, (D2D) terminal, or node e.g. smart phone, laptop, mobile phone, sensor, relay, mobile tablets or even a small base station communicating within a cell. Embodiments herein may be directed towards boosting IP flows in an UP session used by a user of the UE 120.

CN nodes, such as a first CN node 151, and a second CN node 152 may operate in the wireless communications network 100, respectively.

The first CN node 151 may be represented by a Home Subscriber Server (HSS) or a Unified Data Management (UDM) or any other suitable network entity.

The first CN node 151 may for example be arranged to respond to requests for information identifying UP sessions that are available to the UE (120). The first CN node 151 may provide such information based on a subscriber identifier of a user of the UE (120), e.g. a Subscription Permanent Identifier (SUPI).

The second CN node 152 may be represented by any one out of a UDM, Policy Control Function (PCF), Policy and Charging Rules Function (PCRF) or other suitable network entity. The second CN node 152 may be configured to provide configuration data e.g., indicating whether or not boost is allowed for a UP session. The second CN node 152 may be configured to handle Policy and Charging Control (PCC) rules, e.g., for IP flow for the particular UP session, i.e. to configure PCC rules for IP flows of UP sessions to be boosted.

The first CN node 151 and the second CN node 152 may be the same or different CN node. The first CN node 151 and the second CN node 152 may be co-located.

Radio network nodes such as, e.g., a radio network node 110 may operate in the wireless communications network 100. The radio network node 110 may e.g. provides a number of cells, and may use these cells for communicating with other network entities. The radio network node 110 may be a transmission and reception point e.g. a network node, a radio access network node such as a base station, a radio base station, a NodeB, an evolved Node B (eNB, eNodeB, eNode B), an NR/g Node B (gNB), a base transceiver station, a radio remote unit, an Access Point Base Station, a base station router, a transmission arrangement of a radio base station, a stand-alone access point, an antenna unit, a Wireless Local Area Network (WLAN) access point, an Access Point Station (AP STA), an access controller, a UE acting as an access point or a peer in a Device to Device (D2D) communication, or any other network unit capable of communicating with a UE, e.g., the UE 120. The radio network node 110 may handle boosted IP flows and/or UP sessions related to the UE 120, e.g., as PCC rules may be handled in any suitable manner.

AF nodes such as e.g., an AF node 130, may operate in the wireless communications network 100. The AF node 130 may be any suitable AF, e.g., configured to request a boost of an IP flow in a UP session, e.g., for the UE 120. The AF node 130 may be arranged in any suitable CN node, e.g., the first or second CN node 151, 152, or in a separate network outside the wireless communications network 100.

Methods herein may in one aspect be performed by the network node 141, e.g., as part of a NaaS, as part of a NEF or SCEF, or both NaaS and NEF or SCEF. Additionally or alternatively, a Distributed Node (DN) and functionality, e.g. comprised in a cloud 135 as shown in FIG. 1, may be used for performing or partly performing the methods of embodiments herein. The cloud 135 may comprise a cloud network infrastructure. The cloud network infrastructure may e.g. be a collection of hardware and software elements such as computing power, networking, storage, and virtualization resources needed to enable cloud computing in the wireless communications network 100. The cloud 135 may be a public, private, or hybrid cloud environment.

Embodiments herein may relate to a method where the network node 141, e.g., a NEF/SCEF and/or NaaS client, uses the wireless communications network 100 and/or entities therein to learn about the source IP address required to boost an UP session. Some embodiments herein may relate to that the network node 141 e.g. the NEF or

SCEF, and optionally the NaaS, performing the following steps:
1) Obtaining all UP sessions available to a particular UE, e.g., UE 120, using existing methods, e.g., as described in 3GPP TS 29.508 such as in version 18.0.0 or any suitable version,
2) determining whether boost is allowed for a particular UP session based on configuration data e.g., in UDM, PCF/PCRF or other entity, e.g., as obtained from the first CN node 151.
3) applying a PCC rule to a particular IP flow, e.g., in PCF/PCRF, for a UP Session determined to be boost allowed, or applying a PCC rule to a particular IP flow, e.g., in PCF/PCRF, for all UP Sessions being determined to be boost allowed, e.g., and later remove a PCC rule from PDU Sessions not having the particular IP flow. Applying a PCC ruler herein may mean to configured the second CN node 152 with a respective PCC rule.

In other words, embodiments herein may provide a flexible and efficient mechanism for boosting one or multiple IP flows in UP sessions.

A number of embodiments will now be described, some of which may be seen as alternatives, while some may be used in combination.

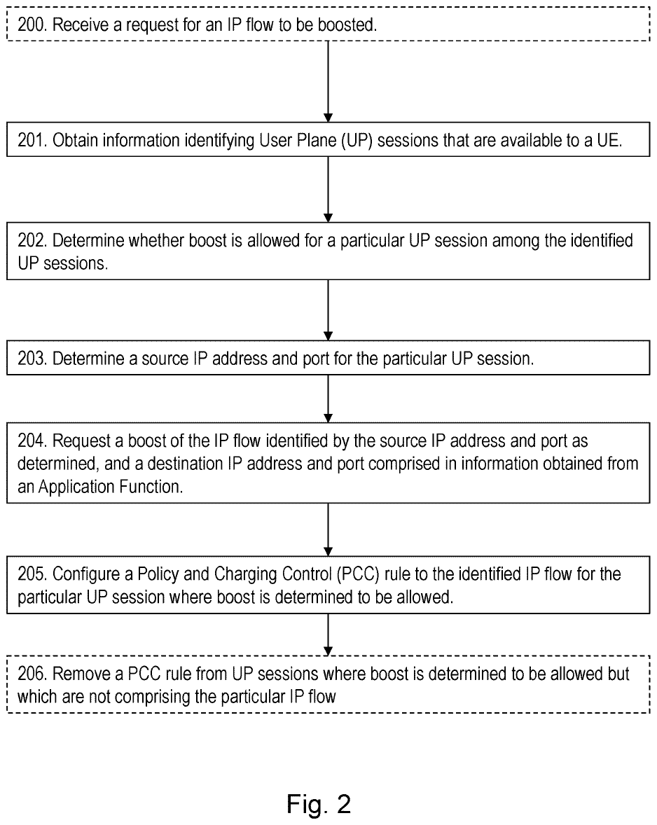

FIG. 2 shows exemplary embodiments of a method performed by the network node 141 for managing an IP flow in a UP session to be boosted on request, e.g., in QoD, by the AF node 130 for the UE 120 in the wireless communications network 100. The UP session may be a PDU session, e.g., in 5 g, or a PDN connection, e.g., in 4G. The network node 141 may be represented by any one or more out of a NEF, a SCEF, or a NaaS. Prior to the actions below, a request for the IP flow to be boosted may have been transmitted by the AF node 130, to the network node 141.

The method comprises the following actions, which actions may be taken in any suitable order. Dashed boxes in FIG. 2 may indicate optional actions.

### Action 200

In some embodiments, if not obtained otherwise, the network node 141 may receive the request for the IP flow to be boosted, as transmitted by the AF node 130, to the network node 141.

### Action 201

The network node 141 obtains from the first CN node 151 information identifying UP sessions that are available to the UE 120, based on a subscriber identifier of a user of the UE 120, e.g. a SUPI. In some embodiments, the first CN node 151 may be represented by a HSS, or a UDM, or any other suitable network entity.

The information may be used to form a list of available UP sessions, e.g., PDU sessions or PDN connections, and whether or not they are boostable.

### Action 202

The network node 141 determines whether boost is allowed for a particular UP session among the identified UP sessions, based on configuration data received from the second CN node 152, such as e.g., UDM, PCF/PCRF, Session Management Function (SMF) or any other suitable network entity.

In other words, the second CN node 152 may be represented by any one out of a UDM, a PCF, a PCRF, or any other suitable network entity, e.g., an SMF.

The network node 141 may determine whether boost is allowed for a particular UP session out of the identified UP sessions by determining whether boost is allowed for multiple UP sessions out of the identified UP sessions.

In other words, some embodiments may only have one UP session to be allowed for boosting, and some embodiments may allow for multiple UP sessions to be allowed for boosting. Whether or not one or multiple UP sessions are allowed for boosting may relate to a configuration, e.g., a preconfigured configuration, and/or may be determined based on any suitable criteria or criterion, e.g., a resource constraint relating to how many IP flows and/or UP sessions can be boosted.

### Action 203

When it is determined that boost is allowed in the particular UP session, the network node 141 determines a source IP address for the particular UP session. The source IP address for the particular UP may be determined based on a subscription on PDN/PDU Connectivity Status Event monitoring notification.

The subscription on PDN/PDU Connectivity Status Event monitoring notification may provide the source IP address for the particular UP session such as in an immediate response to a subscription request.

In other words, the source IP address for the particular UP session may be determined based on the subscriber identifier of a user of the UE 120, e.g. a SUPI, e.g., by request to the first CN node 151, e.g., in combination with action 201 and/or action 202.

The information of the particular UP session may be used to form a list of available UP sessions, e.g., including a source IP address, e.g., as in combination with any one or both of actions 201-202.

### Action 204

The network node 141 requests from the second CN node 152, a boost of the IP flow identified by the source IP address as determined, and a destination IP address and port comprised in information obtained from the AF node 130.

The request may be for an IP flow from an UP session in the list of available UP sessions as formed, e.g., as in any one or more out of actions 201-203.

In some embodiments, the IP flow may use any suitable source port. In the PCC rule, as the source port may be indicated as a wildcard meaning that any port would match, e.g., be mapped, to the PCC rule.

In some embodiments requesting the boost of the IP flow is performed in response to detecting the IP flow in the particular UP session. In other words, the request may be deferred and only configured first when detecting the IP flow.

### Action 205

The network node 141 configures in the second CN node 152, e.g. a PCF and/or a PCRF, a PCC rule to the identified IP flow for the particular UP session where boost is determined to be allowed.

The particular UP session may be from an UP session in the list of available UP sessions as formed, e.g., as in any one or more out of actions 201-203.

The network node 141 may configure in the second CN node 152, a PCC rule to the identified IP flow for the particular UP session when boost is determined to be allowed by configuring in the second CN node 152, a PCC rule to the IP flow for each respective UP session out of the multiple UP sessions where boost is determined to be allowed.

Each respective IP flow may be defined by the source IP address of the particular UP session, and the destination IP address and port as comprised in the information from the AF node 130. The AF node 130 may provide the destination IP address and port, e.g., as part of the request to boost the IP flow.

The PCC rule may cause messages and/or packets of the IP flow(s) in the UP session(s) to be prioritized and/or to be handled in the wireless communications network 100, e.g., by the RAN, e.g., the radio network node 110, e.g., using a higher QoS.

The configuring of the PCC rule may be part of the request to boost the IP flow identified by the source IP address, destination IP address and port as performed in action 204.

In some embodiments, the IP flow may use any suitable source port. In the PCC rule, as the source port may be indicated as a wildcard meaning that any port would match, e.g., be mapped, to the PCC rule.

In some embodiments, configuring the PCC rule to the identified IP flow for the particular UP session is performed in response to detecting the IP flow in the particular UP session. In other words, configuring the PCC rule may be deferred and only configured first when detecting the IP flow.

### Action 206

In some embodiments, the network node 141 may remove a PCC rule from UP sessions where boost is determined to be allowed but which are not comprising the particular IP flow.

In this way resources of the wireless communications network 100 are released such that capacity improvements are obtained for UP sessions that do not comprise the particular IP flow.

Embodiments herein such as the embodiments mentioned above will now be further described and exemplified. The text below is applicable to and may be combined with any suitable embodiment described above.

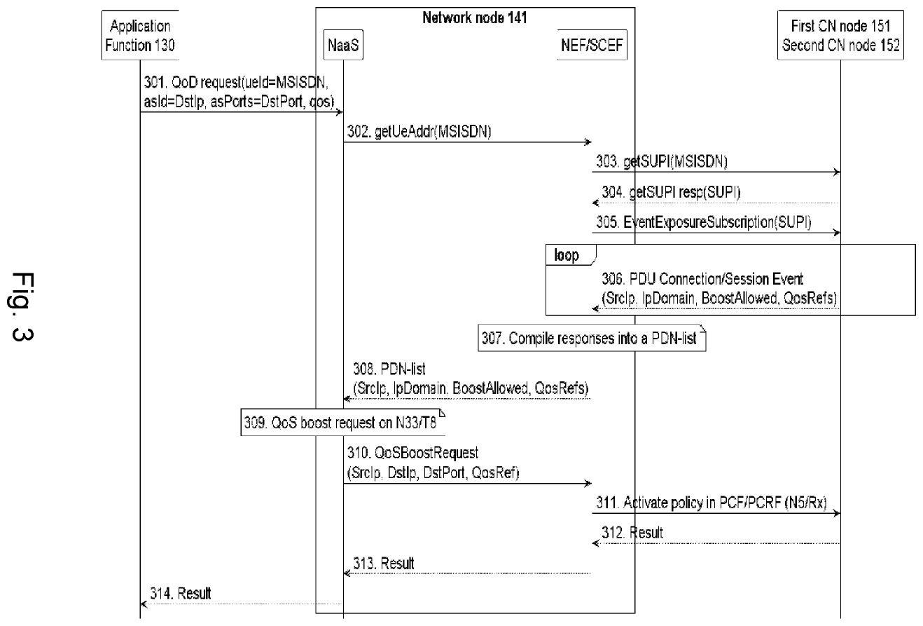

FIG. 3 illustrates one example scenario of embodiments herein. In the example scenario of FIG. 3, the UP sessions referred to as PDU sessions, however, the PDU session could instead be any UP session(s), e.g., PDN connection(s), e.g., in the case of 4G.

The example scenario of FIG. 3 relates to embodiments where only a single PDU Session with IP flows may be boosted.

The example scenario of FIG. 3 may be realized in that an API is exposed by the NEF/SCEF, e.g., of the network node 141, that exposes a list of PDU session(s), e.g., comprising relevant data to identify a correct source IP address to be comprised in a boost request for an IP flow.

For any embodiments herein, not restricted to the example scenario of FIG. 3, each UP Session may comprise or be associated with any one or more out of the following information elements:
a source IP—the UE, e.g., the UE 120, assigned ‘private’ IP address to be included in a boost request, e.g., a N33/T8 boost request,
an IP domain—in case of an overlapping IP address assignment, the IP domain provide a context, the context may be a particular UPF/PGW or other subnetworks,
a Boost-allowed indicator which indicates whether or not the UP Session is eligible for boost,
one or more QoS reference(s), e.g., a list of available QoS references. The QoS references may indicate the allowed QoS classes for boost.

FIG. 3 illustrates an embodiment relating to learning about the source IP address from the core network, e.g., determining the source IP address for a particular UP session, e.g., provided by the core network 151, e.g., as part of action 203.

The example scenario of FIG. 3 may relate to the below actions, which actions may be combined with, or be part of, above actions 201-206.
Action 301. The AF node 130 may request from an NaaS, e.g., of the network node 141, for a boost of an IP flow indicated by a Destination IP (DstIP) and Destination Port (DstPort). A Source IP is not provided by the AF node 130 but may be determined based on a Mobile Station International Subscriber Directory Number (MSISDN). The MSISDN may be provided by the AF node 130 in clear, e.g., unencrypted, or alternatively be embedded in a token, e.g., an access token. Embodiments herein may alternatively use any suitable mechanism(s) for determining or obtaining the MSISDN.
Action 302. The NaaS, e.g., of the network node 141, may request a list of all PDU Sessions for the MSISDN to the NEF/SCEF of the network node 141, and may further determine which session may have boosted IP flows. Only one PDU Session may be possible or allowed in the example scenario of FIG. 3. Action 302 may relate to, and/or may be combined with action 203 above.
Action 303. The NEF/SCEF, e.g., of the network node 141, may request a subscribed identifier, e.g., a SUPI, for the provided MSISDN from the Core Network, e.g., the first CN node 151 or the second core network 152. This may be done using any suitable mechanism, e.g., by using a Sh query to an HSS/UDM, e.g., the first CN node 151 or the second core network 152, e.g., as in 3GPP TS 29.329, or via a GSMA/CAMARA API. Action 303 may relate to, and/or may be combined with any one or more out of action 201, 202, and 203 above.
Action 304. The Core Network, e.g., the first CN node 151 or the second core network 152, may send a response with the subscriber identifier, e.g., the requested SUPI. Action 304 may relate to, and/or may be combined with any one or more out of action 201, 202, and 203 above.
Action 305. The NEF/SCEF, e.g., of the network node 141, may request from the Core Network, e.g., the first CN node 151 or the second core network 152, a one-time subscription request of info on UP sessions, e.g., as in 3GPP TS 29.508. The one time subscription request may be a request at least partly for any one or more out of, typically all of: a source IP, an IP domain, a boost allowed indicator, one or more QoS references, for one or more respective PDU sessions. Action 305 may relate to, and/or may be combined with any one or more out of action 201, 202, and 203 above.
Action 306. The NEF/SCEF, e.g., of the network node 141, may receive a notification once for each PDU Session, e.g., the PDU sessions identified in action 201 and/or all UP sessions as a single reply. The response may comprise information about whether each respective PDU session may be boosted, “boostAllowed”, and, if so, optionally with what QoS class(es). This information may be provisioned as part of a user profile e.g., of a user of the UE 120, in a Business Support System (BSS), HSS/UDM or other suitable entity, e.g., the first CN node 151 or the second CN node 152. One alternative is to extend the UDM DnnConfiguration table, e.g., as in 3GPP TS 29.503 such as version 18.0.0 or any suitable version, table 6.1.6.2.9-1, with attributes “boostAllowed” (Boolean) and optionally “QoSReferences” with allowed QoS classes. Action 306 may relate to, and/or may be combined with any one or more out of action 201, 202, and 203 above.
Action 307. All responses may be compiled into a PDU session list, e.g., by the NEF/SCEF, e.g., of the network node 141. Action 307 may relate to, and/or may be combined with any one or more out of action 201, 202, and 203 above.
Action 308. The compiled PDU session list may be provided to NaaS, e.g., of the network node 141. The NaaS may check, e.g., inspect, the PDU session-list for the user, e.g., of the UE 120. The NaaS may determine which PDU Session, if any, is allowed to have boosted QoS and with what class(es) via the new “boostAllowed” and optional “QoSReference” attributes. Action 308 may relate to, and/or may be combined with any one or more out of action 201, 202, and 203 above.
Action 309. If the requested QoS class matches an allowed QoS reference, the QoS boost request may be sent, e.g., as part of any one or both of actions 204-205, using the Source IP address of the PDU session marked with “boostAllowed” as a source IP (SrcIp). Action 309 may relate to, and/or may be combined with any one or more out of action 204, and 205 above.
Action 310. The NaaS, e.g., of the network node 141, may transmit a boost request, herein referred to as a QoS boost request, e.g., as part of any one or both of actions 204-205, towards the core network, e.g., the first CN node 151 or the second CN node 152, e.g., via the NEF/SCEF of the network node 141. The QoS boost request may comprise or otherwise indicate the destination IP address (DstIP), and the corresponding port (DstPort) e.g., as provided by the AF node 130 in action 301. This action may relate to or be combined with similar step of 3GPP TS 23.682. Action 310 may relate to, and/or may be combined with any one or more out of action 204, and 205 above.
Action 311. The SCEF/NEF, e.g., of the network node 141, may activate an appropriate PCC rule with the requested QoS in PCF/PCRF to be applied on the indicated flow, e.g., as part of action 204 and/or action 205.
Action 312. Result e.g., of the above actions may be transmitted to the NEF/SCEF, e.g., of the network node 141.
Action 313. Result e.g., of the above actions may be transmitted to the NaaS, e.g., of the network node 141.
Action 314. Result e.g., of the above actions may be transmitted to the AF node 130.

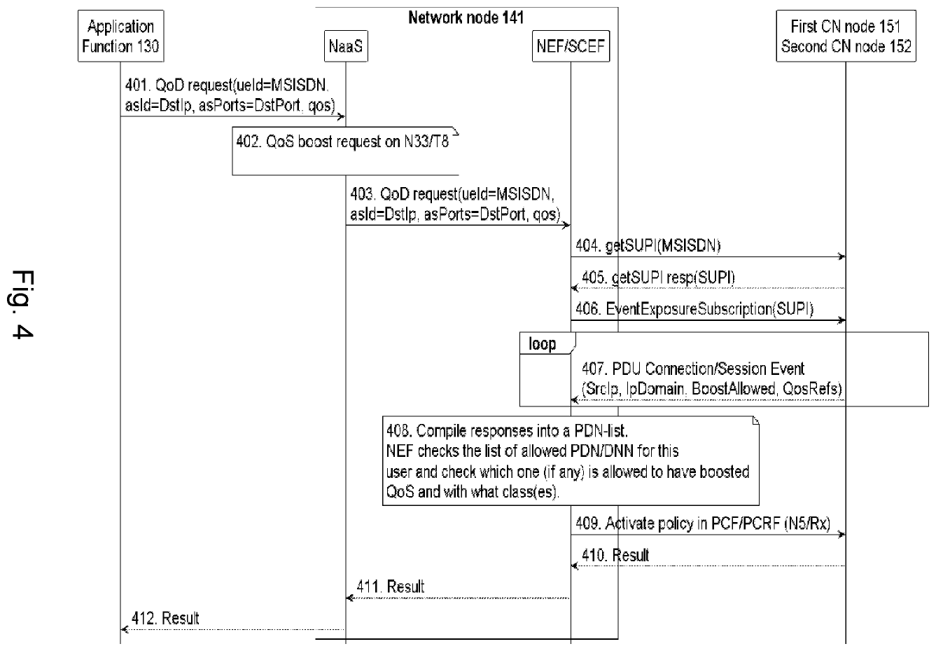

In some embodiments, as illustrated in an example scenario of FIG. 4, multiple UP sessions, e.g., PDU Sessions or PDN connections, with IP flows may be boosted.

The example scenario of FIG. 4 may relate to the below actions, which actions may be combined with, or be part of, above actions 201-206. The actions of example scenario of FIG. 4 may be largely the same as in the Example scenario of FIG. 3 except for that a functionality to select a correct source IP address is in the example scenario of FIG. 3 embedded in the NEF/SCEF of the network node 141. The actions may otherwise the same as in actions 301-314.

The actions of the example scenario of FIG. 4 may comprise any one or more out of the following actions in any suitable order.
Action 401. The AF node 130 may request from to NaaS, e.g., of the network node 141, for a boost of an IP flow indicated by a Destination IP (DstIP) and Destination Port (DstPort). A Source IP is not provided by the AF node 130 but may be determined based on a Mobile Station International Subscriber Directory Number (MSISDN). The MSISDN may be provided by the AF node 130 in clear, e.g., unencrypted, or alternatively be embedded in a token, e.g., an access token. Embodiments herein may alternatively use any suitable mechanism(s) for determining or obtaining the MSISDN.
Action 402. The NaaS, e.g., of the network node 141, may initiate a boost request, e.g., on N33/T8.
Action 403. The NaaS, e.g., of the network node 141, may transmit a QoD request indicative of a UE identifier, e.g., of the UE 120 such as a MSISDN, a destination IP, destination port, and a QoS indicator, e.g., of requested QoS, QoS references, and/or QoS class(es).
Action 404. The NEF/SCEF, e.g., of the network node 141, may request a subscribed identifier, e.g., a SUPI, for the provided MSISDN from the Core Network, e.g., the first CN node 151 or the second core network 152. This may be done using any suitable mechanism, e.g., by using an Sh query to an HSS/UDM, e.g., the first CN node 151 or the second core network 152, e.g., as in 3GPP TS 29.329, or via a GSMA/CAMARA API. Action 404 may relate to, and/or may be combined with any one or more out of action 201, 202, and 203 above.
Action 405. The Core Network, e.g., the first CN node 151 or the second core network 152, may send a response with the subscriber identifier, e.g., the requested SUPI. Action 405 may relate to, and/or may be combined with any one or more out of action 201, 202, and 203 above.
Action 406. The NEF/SCEF, e.g., of the network node 141, may request from the Core Network, e.g., the first CN node 151 or the second core network 152, a one-time subscription request of info on PDU sessions, e.g., as in 3GPP TS 29.508. The one-time subscription request may be a request at least partly for any one or more out of, typically all of: a source IP, an IP domain, a boost allowed indicator, one or more QoS references, for one or more respective PDU sessions. Action 406 may relate to, and/or may be combined with any one or more out of action 201, 202, and 203 above.
Action 407. The NEF/SCEF, e.g., of the network node 141, may receive a notification once for each PDU Session, e.g., the PDU sessions identified in action 201. The response may comprise information about whether each respective PDU session may be boosted, “boostAllowed”, and, if so, optionally with what QoS class(es). This information may be provisioned as part of a user profile e.g., of a user of the UE 120, in a Business Support System (BSS), HSS/UDM or other suitable entity, e.g., the first CN node 151 or the second CN node 152. One alternative is to extend the UDM DnnConfiguration table, e.g., as in 3GPP TS 29.503//Version?, table 6.1.6.2.9-1, with attributes “boostAllowed” (Boolean) and optionally “QoSReferences” with allowed QoS classes. Action 407 may relate to, and/or may be combined with any one or more out of action 201, 202, and 203 above.
Action 408. All responses may be compiled into a PDU session list, e.g., by the NEF/SCEF, e.g., of the network node 141. Action 408 may relate to, and/or may be combined with any one or more out of action 201, 202, and 203 above. The SCEF/NEF may check, e.g., inspect, the PDU session-list for the user, e.g., of the UE 120. The SCEF/NEF may determine which PDU Session, if any, is allowed to have boosted QoS and with what class(es) via the new “boostAllowed” and optional “QoSReference” attributes. Action 408 may relate to, and/or may be combined with any one or more out of action 201, 202, and 203 above.
Action 409. If the requested QoS class matches an allowed QoS reference, the QoS boost request may be sent, e.g., as part of any one or both of actions 204-205, using the Source IP address of the PDU session marked with “boostAllowed” as a source IP (SrcIp). Action 409 may relate to, and/or may be combined with any one or more out of action 204, and 205 above.
Action 410. The SCEF/NEF, e.g., of the network node 141, may activate an appropriate PCC rule with the requested QoS in PCF/PCRF to be applied on the indicated flow, e.g., using N5/Rx, e.g., as part of action 204 and/or action 205.
Action 411. Result e.g., of the above actions may be transmitted to the NEF/SCEF, e.g., of the network node 141.
Action 412. Result e.g., of the above actions may be transmitted to the NaaS, e.g., of the network node 141.
Action 413. Result e.g., of the above actions may be transmitted to the AF node 130.

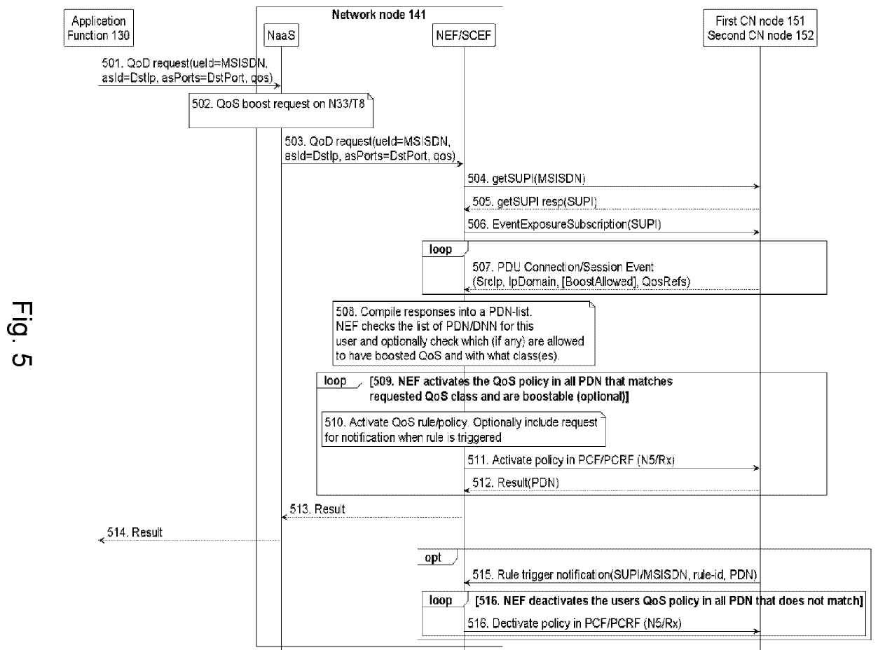

Embodiments herein, e.g., as illustrated by the example scenario of FIG. 5, may comprise installing a PCC policy/rule for all PDU Sessions that are marked as boostable, e.g., using a “boostAllowed” indicator, and that may allow a requested QoS class, as indicted by a “QoSReference” indicator. This may relate to and/or be combined with any one or more out of actions 204-205 above. The policy/rule may in some embodiments only be used/triggered in a PDU Session where an IP flow which is associated with a particular destination 3-tuple comprising an IP address, a Port and a Protocol, e.g., UDP or TCP. The PCC policy/rule may in some embodiments never be triggered in any other PDU Session and the policy/rule may be removed, e.g., as in action 206, from these PDU Sessions once the PDU Session having the flow has been determined. The removal, e.g., as in 206, is optional but may improve processing of traffic in the non-boosted PDU Sessions since the rule will not have effect in the non-boosted PDU sessions but may will still need to be evaluated and hence produce load. Hence if it is removed where applicable, higher performance is achieved.

In some embodiments, an alternative is to defer installation of a PCC rule to after the detection of the PDU session in which the IP flow has been established and only then install the PCC rule for that PDU session. This is typically beneficial if the amount of PCC rules for a boostable PDU session is reaching any upper design or capacity limits.

Embodiments herein, e.g., as illustrated by the example scenario of FIG. 5, may retrieve a list of PDU Sessions e.g., as in actions 301-314, and/or 401-412 above, or as part of actions 201-203. The data in the list of PDU sessions may be any one or more out of the following information elements:
a source IP—the UE, e.g., the UE 120, assigned ‘private’ IP address to be included in a boost request, e.g., a N33/T8 boost request, an IP domain—in case of an overlapping IP address assignment, the IP domain provide a context,
a Boost-allowed indicator which indicates whether or not the PDU Session is eligible for boost,
one or more QoS reference(s), e.g., a list of available QoS references.

Embodiments herein, e.g., as illustrated by the example scenario of FIG. 5, may allow the NEF/SCEF and/or NaaS client of the network node 141 to:
1. Select a source IP address for every PDU Session for which QoS boost is allowed, e.g., as in actions 201-203 above, and which may be requested in a subsequent QoS boost NEF/SCEF request, e.g., as in actions 204-205 above, and
2. assure/ensure that the requested QoS is allowed for this user.

To minimize the number of PDU Sessions that may be targeted, e.g., for boost, the QoS class may be indicated from the AF node 130, and could be differentiated, e.g., implying that UP sessions not supporting the indicated QoS class will not be subject for the boost PCC rule.

Embodiment, e.g., as illustrated by the example scenario of FIG. 5, herein may be initiated by an API request which may further be initiated either by the NaaS-layer and/or handled inside the SCEF/NEF of the network node 141.

In the example scenario of FIG. 5, the Actions 501-507 may correspond to any one or more out of actions 301-306 and/or actions 401-407 in the actions above, in any suitable order. The actions of the example scenario of FIG. 5 may be part of and/or combinable with any one or more out of the actions 201-206 above. The example scenario of FIG. 5 may further relate to any one or more out of the following actions, in any suitable order.

### Action 508

The NEF/SCEF of the network node 141 may compile responses, e.g., results of obtaining the list of available PDU sessions and whether they are boostable, into a PDN list. The NEF/SCEF of the network node 141 may check the list of allowed PDN/DNN for a user of the boost request, e.g., as requested by the AF node and/or the NaaS of the network node 141 in actions 501-502, and check which one or more UP sessions (if any) is allowed to have boosted QoS, and optionally for what QoS classes.

### Action 509

The NEF/SCEF of the network node 141 may activate a QoS policy in PDN or PDU session that matchers a requested QoS class and/or are boostable.

### Action 510

The NEF/SCEF of the network node 141 may initiate a notification subscription with the first CN node 151 and/or the second CN node 152, which may be arranged to notify the AF node 130 and/or the NEF/SCEF of the network node 141, of when the installed PCC rule has been triggered. The notification is illustrated in actions step 515.

### Action 510

The NEF/SCEF of the network node 141 may transit an activation of the policy or rule, e.g., to boost the IP flow/UP session, to the first CN node 151 and/or the second CN node 152.

### Action 511

Result e.g., of the above actions may be transmitted to the NEF/SCEF, e.g., of the network node 141.

### Action 512

Result e.g., of the above actions may be transmitted to the NaaS, e.g., of the network node 141.

### Action 513

Result e.g., of the above actions may be transmitted to the AF node 130.

### Action 515

The rule trigger notification may be triggered to be received by the NEF/SCEF of the network node 141. The received notification may indicate that the PCC rule has been triggered.

### Action 516

The NEF/SCEF of the network node 141 may deactivate a QoS/PCC policy/rule which does not match a requested PDN to be boosted. The action may be combinable and/or relate to action 206.

Actions 515 and/or 516 may be performed if the option to remove the PCC rule from the non-affected PDU sessions is used, e.g., as in action 206.

### Additional Variants and/or Embodiments

Some embodiments herein may comprise having have the PCF/PCRF, e.g., the first CN node 151 and/or the second CN node 152, to fetch the “boostAllowed” and/or “QoSReference” data from a UDM, e.g., when stored in UDM, e.g., the first CN node 151 and/or the second CN node 152, as in the example scenario of FIG. 3. In some of these embodiments, this would enable he first CN node 151 and/or the second CN node 152, to directly apply appropriate settings for every PDU session itself, rather than having NEF/SCEF of the network node 141 retrieve and/or compile a list of PDU Sessions.

In some other embodiments, the “boostAllowed” and/or “QoS reference” data directly may be configured in PCF/PCRF, e.g., the first CN node 151 and/or the second CN node 152, that is, no additional data in UDM may need to be provisioned.

To perform the method actions above, the network node 141 may be configured to manage an IP flow in a User Plane, UP, session to be boosted on request, e.g., in QoD, by the AF node 130 for the UE 120 in the wireless communications network 100.

The network node 141 may be adapted to comprise a NaaS and/or a SCEF/NEF to perform the embodiments herein.

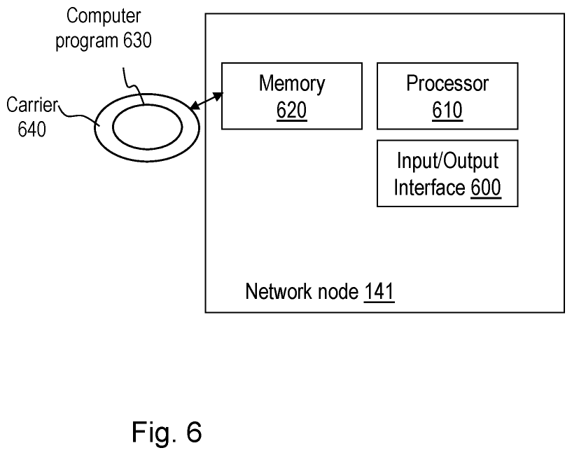

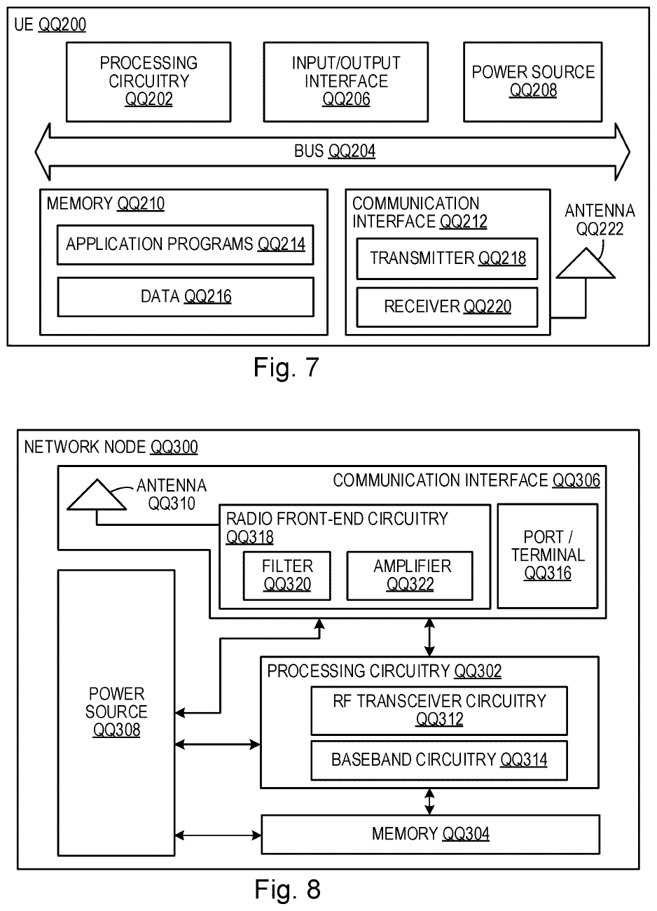

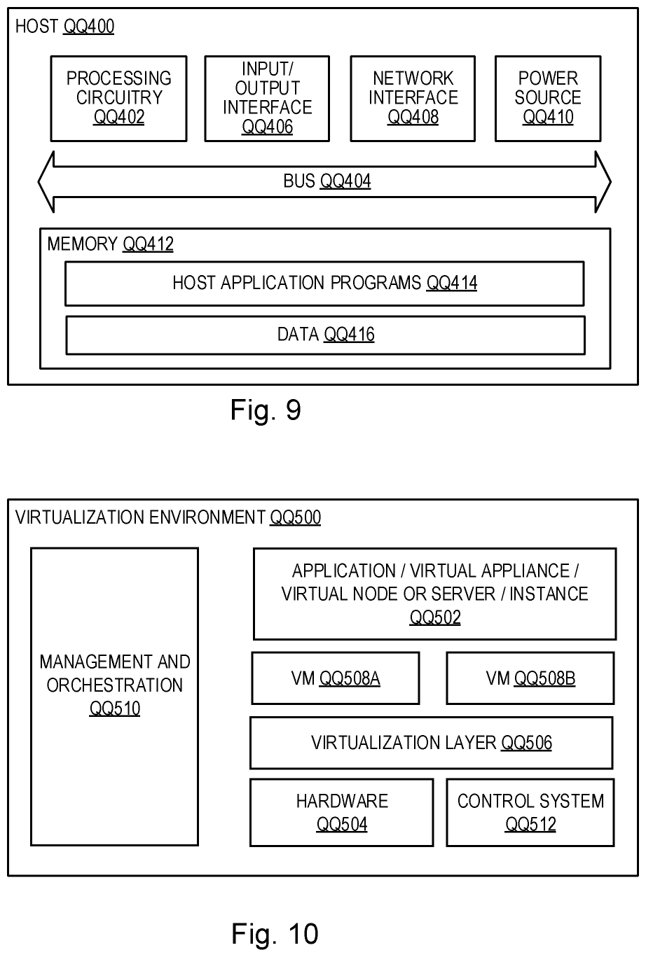

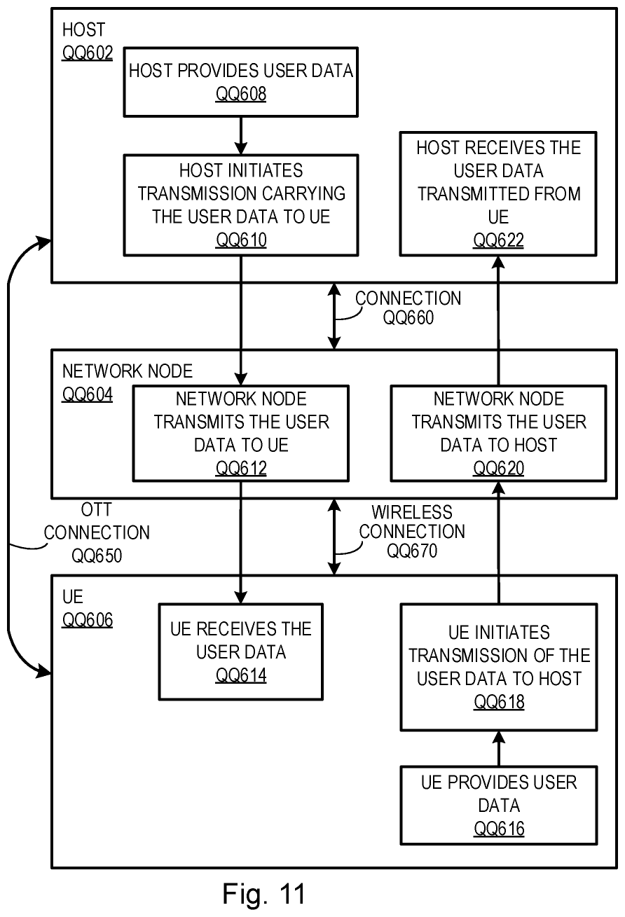

The network node 141 may comprise an arrangement depicted in FIG. 6. The network node 141 may comprise an input and output interface 600 configured to communicate in the wireless communications network 100, e.g., with any one or more out of the AF node 130, the first CN node 151, the second CN node 152, the radio network node 110, and/or the UE 120. The input and output interface 700 may comprise a wireless receiver (not shown), and a wireless transmitter (not shown).

The embodiments herein may be implemented through a processor or one or more processors, such as a processor 610 of a processing circuitry in the network node 141 depicted in FIG. 6 together with a computer program code for performing the functions and actions of the embodiments herein. The program code mentioned above may also be provided as a computer program product, for instance in the form of a data carrier carrying computer program code for performing the embodiments herein when being loaded into the network node 141. One such carrier may be in the form of a CD ROM disc. It is however feasible with other data carriers such as a memory stick. The computer program code may y furthermore be provided as pure program code on a server and downloaded to the network node 141.

The network node 141 may further be configured to perform any one or more out of the actions 201-206 above, in any suitable order. Additionally or alternatively, the network node 141 may be configured to perform any suitable action of actions 301-314, 401-412, and/or 501-516.

The network node 141 and/or processor 610 is configured to manage an IP flow in a UP session to be boosted on request by the AF node 130 for the UE 120 in the wireless communications network 100.

The network node 141 and/or processor 610 is configured to:
obtain from the first CN node 151, information identifying UP sessions that are available to the UE 120, based on a subscriber identifier of a user of the UE 120,
determine whether boost is allowed for a particular UP session among the identified UP sessions, based on configuration data received from a second CN node 152,
when it is determined that boost is allowed in the particular UP session, determine a source IP address for the particular UP session,
request from the second CN node 152, a boost of the IP flow identified by the source IP address as determined, and a destination IP address and port comprised in information obtained from the AF node 130, and
configure in the second CN node 152, a PCC rule to the identified IP flow for the particular UP session where boost is determined to be allowed.

In some embodiments, the network node 141 and/or processor 610 is configured to:
determine whether boost is allowed for a particular UP session out of the identified UP sessions by determining whether boost is allowed for multiple UP sessions out of the identified UP sessions, and
configure in the second CN node 152, a PCC rule to the identified IP flow for the particular UP session when boost is determined to be allowed by configuring in the second CN node 152, a PCC rule to the IP flow for each respective UP session out of the multiple UP sessions where boost is determined to be allowed.

In some embodiments, requesting the boost of the IP flow and/or configuring the PCC rule to the identified IP flow for the particular UP session is performed in response to detecting the IP flow in the particular UP session.

In some embodiments, the network node 141 and/or processor 610 is configured to:
receive a request for the IP flow to be boosted, as transmitted by the AF node 130 to the network node 141.

In some embodiments, the network node 141 and/or processor 610 is configured to:
remove a PCC rule from UP sessions where boost is determined to be allowed but which are not comprising the particular IP flow.

In some embodiments, the network node 141 is adapted to be represented by any one or more out of a NEF, a SCEF, or a NaaS.

In some embodiments, the first CN node 151 is adapted to be represented by a HSS or a UDM, or other entity.

In some embodiments, the second CN node 152 is adapted to be represented by any one out of a UDM, PCF, PCRF, or other entity.

In some embodiments, the UP session is adapted to be represented by any one out of: a PDU session or a PDN connectivity. In some of these embodiments, the UP session is adapted to be a user plane connectivity in a wireless data network associated with the wireless communications network 100.

The network node 141 may further comprise a memory 620 comprising one or more memory units. The memory 620 comprises instructions executable by the processor in the network node 141. The memory 720 are arranged to be used to store e.g., parameters, QoS requests, MSISDN, IP addresses, ports, boost allowed indicators, states, information, indications, data, configurations, communication data, and applications to perform the methods herein when being executed in the network node 141.

In some embodiments, a computer program 630 comprising instructions, which when executed by the at least one processor 610, cause the at least one processor of first network node 141 to perform the actions above.

In some embodiments, a carrier 640 comprises the computer program 630, wherein the carrier 640 is one of an electronic signal, an optical signal, an electromagnetic signal, a magnetic signal, an electric signal, a radio signal, a microwave signal, or a computer-readable storage medium.

Those skilled in the art will appreciate that units in the network node 141 described above may refer to a combination of analog and digital circuits, and/or one or more processors configured with software and/or firmware, e.g. stored in the network node 141, that when executed by the one or more processors such as the processors described above. One or more of these processors, as well as the other digital hardware, may be included in a single Application-Specific Integrated Circuitry ASIC, or several processors and various digital hardware may be distributed among several separate components, whether individually packaged or assembled into a System-on-a-Chip (SoC).

### EMBODIMENTS

Below, some example Embodiments 1-12 are shortly described. See e.g. FIGS. 1, 2, 3, 4, 5, and 6.

### Claims

Embodiment 1. A method performed by a network node 141, for managing an IP flow in a User Plane, UP, session to be boosted on request, e.g., in QoD, by an Application Function, AF, node 130 for a User Equipment, UE, 120 in a wireless communications network 100, the method comprising any one or more out of:
obtaining 201 from a first Core Network, CN, node 151 e.g., HSS/UDM, information identifying UP sessions that are available to the UE 120, based on a subscriber identifier of a user of the UE 120, e.g. SUPI
determining 202 whether boost is allowed for a particular UP session among the identified UP sessions, based on configuration data received from a second CN node 152, such as e.g., UDM, PCF/PCRF, SMF or other entity,
when it is determined that boost is allowed in the particular UP session, determining 203 a source IP address for the particular UP session, e.g. based on subscription on PDN/PDU Connectivity Status Event monitoring notification,
requesting 204 from a second CN node 152, a boost of the IP flow identified by the source IP address as determined, and a destination IP address and port comprised in information obtained from the AF node 130, and
configuring 205 in the second CN node 152, e.g. PCF/PCRF, a Policy and Charging Control, PCC, rule to the identified IP flow for the particular UP session where boost is determined to be allowed.

Embodiment 2. The method according to Embodiment 1, wherein,
determining 202 whether boost is allowed for a particular UP session out of the identified UP sessions comprises determining whether boost is allowed for multiple UP sessions out of the identified UP sessions, and
configuring 205 in the second CN node 152, a PCC rule to the identified IP flow for the particular UP session when boost is determined to be allowed comprises configuring in the second CN node 152, a PCC rule to the IP flow for each respective UP session out of the multiple UP sessions where boost is determined to be allowed.

Embodiment 3. The method according to any one of the Embodiments 1-2, further comprising:
removing 206 a PCC rule from UP sessions where boost is determined to be allowed but which are not comprising the particular IP flow.

Embodiment 4. The method according to any of the Embodiments 1-3, wherein any one or more out of:
the network node 141 is represented by any one or more out of a Network Exposure Function, NEF, a Service Capability Exposure Function, SCEF, or a Network as a Service, NaaS,
the first CN node 151 is represented by a Home Subscriber Server, HSS, or a Unified Data Management, UDM, or other network entity, and
the second CN node 152 is represented by any one out of a UDM, PCF, PCRF or other entity.

Embodiment 5. The method according to any of the Embodiments 1-4, wherein
the UP session is represented by any one out of: a Packet Data Network, PDU, session or a Packet Data Network, PDN, connectivity, and which UP session is a user plane connectivity in a wireless data network associated with the wireless communications network 100.

Embodiment 6. A computer program 630 comprising instructions, which when executed by a processor 610, causes the processor 610 to perform actions according to any of the Embodiments 1-5.

Embodiment 7. A carrier 640 comprising the computer program 630 of Embodiment 6, wherein the carrier 640 is one of an electronic signal, an optical signal, an electromagnetic signal, a magnetic signal, an electric signal, a radio signal, a microwave signal, or a computer-readable storage medium.

Embodiment 8. A network node 141, configured to manage an IP flow in a User Plane, UP, session to be boosted on request, e.g., in QoD, by an Application Function, AF, node 130 for a User Equipment, UE, 120 in a wireless communications network 100, the network node 141 further being configured to any one or more out of:
obtain from a first Core Network, CN, node 151 e.g., HSS/UDM, information identifying UP sessions that are available to the UE 120, based on a subscriber identifier of a user of the UE 120, e.g. SUPI
determine whether boost is allowed for a particular UP session among the identified UP sessions, based on configuration data received from a second CN node 152, such as e.g., UDM, PCF/PCRF, SMF or other entity,
when it is determined that boost is allowed in the particular UP session, determine a source IP address for the particular UP session, e.g., based on subscription on PDN/PDU Connectivity Status Event monitoring notification,
request from a second CN node 152, a boost of the IP flow identified by the source IP address as determined, and a destination IP address and port comprised in information obtained from the AF node 130, and
configure in the second CN node 152, e.g. PCF/PCRF, a Policy and Charging Control, PCC, rule to the identified IP flow for the particular UP session where boost is determined to be allowed.

Embodiment 9. The network node 141 according to Embodiment 8, wherein,
determine whether boost is allowed for a particular UP session out of the identified UP sessions by determining whether boost is allowed for multiple UP sessions out of the identified UP sessions, and
configure in the second CN node 152, a PCC rule to the identified IP flow for the particular UP session when boost is determined to be allowed by configuring in the second CN node 152, a PCC rule to the IP flow for each respective UP session out of the multiple UP sessions where boost is determined to be allowed.

Embodiment 10. The network node 141 according to any of Embodiments 8-9, further configured to:
remove a PCC rule from UP sessions where boost is determined to be allowed but which are not comprising the particular IP flow.

Embodiment 11. The network node 141 according to any of the Embodiments 8-10, wherein any one or more out of:
the network node 141 is adapted to be represented by any one or more out of a NEF, a SCEF, or a Naas,
the first CN node 151 is adapted to be represented by a HSS, or a UDM, or other entity, and
the second CN node 152 is adapted to be represented by any one out of a UDM, PCF, PCRF or other entity.

Embodiment 12. The network node 141 according to any of the Embodiments 8-11, wherein the UP session is adapted to be represented by any one out of: a Packet Data Network, PDU, session or a Packet Data Network, PDN, connectivity, and which UP session is adapted to be a user plane connectivity in a wireless data network associated with the wireless communications network 100.

### Additional Explanation

Some of the embodiments contemplated herein will now be described more fully with reference to the accompanying drawings. Embodiments are provided by way of example to convey the scope of the subject matter to those skilled in the art.

FIG. 1 shows an example of a communication system QQ100 in accordance with some embodiments.

In the example, the communication system QQ100 includes a telecommunication network QQ102, e.g., the wireless communications network 100, that includes an access network QQ104, such as a radio access network (RAN), and a core network QQ106, which includes one or more core network nodes QQ108, e.g., the network node 141, and/or any of the first or second CN nodes 151, 152. The access network QQ104 includes one or more access network nodes, e.g., the radio network node 110, such as network nodes QQ110a and QQ110b (one or more of which may be generally referred to as network nodes QQ110), or any other similar 3rd Generation Partnership Project (3GPP) access nodes or non-3GPP access points. Moreover, as will be appreciated by those of skill in the art, a network node is not necessarily limited to an implementation in which a radio portion and a baseband portion are supplied and integrated by a single vendor. Thus, it will be understood that network nodes include disaggregated implementations or portions thereof. For example, in some embodiments, the telecommunication network QQ102 includes one or more Open-RAN (ORAN) network nodes. An ORAN network node is a node in the telecommunication network QQ102 that supports an ORAN specification (e.g., a specification published by the O-RAN Alliance, or any similar organization) and may operate alone or together with other nodes to implement one or more functionalities of any node in the telecommunication network QQ102, including one or more network nodes QQ110 and/or core network nodes QQ108.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time control application (e.g., xApp) or a non-real time control application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Moreover, an ORAN access node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance or comparable technologies. The network nodes QQ110 facilitate direct or indirect connection of user equipment (UE), e.g., the UE 120, such as by connecting UEs QQ112a, QQ112b, QQ112c, and QQ112d (one or more of which may be generally referred to as UEs QQ112) to the core network QQ106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system QQ100 may include any number of wired or wireless networks, network nodes, UEs, and/or any other components or systems that may facilitate or participate in the communication of data and/or signals whether via wired or wireless connections. The communication system QQ100 may include and/or interface with any type of communication, telecommunication, data, cellular, radio network, and/or other similar type of system.

The UEs QQ112 may be any of a wide variety of communication devices, including wireless devices arranged, configured, and/or operable to communicate wirelessly with the network nodes QQ110 and other communication devices. Similarly, the network nodes QQ110 are arranged, capable, configured, and/or operable to communicate directly or indirectly with the UEs QQ112 and/or with other network nodes or equipment in the telecommunication network QQ102 to enable and/or provide network access, such as wireless network access, and/or to perform other functions, such as administration in the telecommunication network QQ102.

In the depicted example, the core network QQ106 connects the network nodes QQ110 to one or more hosts, such as host QQ116. These connections may be direct or indirect via one or more intermediary networks or devices. In other examples, network nodes may be directly coupled to hosts. The core network QQ106 includes one more core network nodes (e.g., core network node QQ108) that are structured with hardware and software components. Features of these components may be substantially similar to those described with respect to the UEs, network nodes, and/or hosts, such that the descriptions thereof are generally applicable to the corresponding components of the core network node QQ108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host QQ116 may be under the ownership or control of a service provider other than an operator or provider of the access network QQ104 and/or the telecommunication network QQ102, and may be operated by the service provider or on behalf of the service provider. The host QQ116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system QQ100 of FIG. 1 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMAX), Bluetooth, Z-Wave, Near Field Communication (NFC) ZigBee, LiFi, and/or any low-power wide-area network (LPWAN) standards such as LoRa and Sigfox.

In some examples, the telecommunication network QQ102 is a cellular network that implements 3GPP standardized features. Accordingly, the telecommunications network QQ102 may support network slicing to provide different logical networks to different devices that are connected to the telecommunication network QQ102. For example, the telecommunications network QQ102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs QQ112 are configured to transmit and/or receive information without direct human interaction. For instance, a UE may be designed to transmit information to the access network QQ104 on a predetermined schedule, when triggered by an internal or external event, or in response to requests from the access network QQ104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub QQ114 communicates with the access network QQ104 to facilitate indirect communication between one or more UEs (e.g., UE QQ112c and/or QQ112d) and network nodes (e.g., network node QQ110b). In some examples, the hub QQ114 may be a controller, router, content source and analytics, or any of the other communication devices described herein regarding UEs. For example, the hub QQ114 may be a broadband router enabling access to the core network QQ106 for the UEs. As another example, the hub QQ114 may be a controller that sends commands or instructions to one or more actuators in the UEs. Commands or instructions may be received from the UEs, network nodes QQ110, or by executable code, script, process, or other instructions in the hub QQ114. As another example, the hub QQ114 may be a data collector that acts as temporary storage for UE data and, in some embodiments, may perform analysis or other processing of the data. As another example, the hub QQ114 may be a content source. For example, for a UE that is a VR headset, display, loudspeaker or other media delivery device, the hub QQ114 may retrieve VR assets, video, audio, or other media or data related to sensory information via a network node, which the hub QQ114 then provides to the UE either directly, after performing local processing, and/or after adding additional local content. In still another example, the hub QQ114 acts as a proxy server or orchestrator for the UEs, in particular if one or more of the UEs are low energy IoT devices.

The hub QQ114 may have a constant/persistent or intermittent connection to the network node QQ110b. The hub QQ114 may also allow for a different communication scheme and/or schedule between the hub QQ114 and UEs (e.g., UE QQ112c and/or QQ112d), and between the hub QQ114 and the core network QQ106. In other examples, the hub QQ114 is connected to the core network QQ106 and/or one or more UEs via a wired connection. Moreover, the hub QQ114 may be configured to connect to an M2M service provider over the access network QQ104 and/or to another UE over a direct connection. In some scenarios, UEs may establish a wireless connection with the network nodes QQ110 while still connected via the hub QQ114 via a wired or wireless connection. In some embodiments, the hub QQ114 may be a dedicated hub—that is, a hub whose primary function is to route communications to/from the UEs from/to the network node QQ110b. In other embodiments, the hub QQ114 may be a non-dedicated hub—that is, a device which is capable of operating to route communications between the UEs and network node QQ110b, but which is additionally capable of operating as a communication start and/or end point for certain data channels.

FIG. 2 shows a UE QQ200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle, vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE QQ200 includes processing circuitry QQ202 that is operatively coupled via a bus QQ204 to an input/output interface QQ206, a power source QQ208, a memory QQ210, a communication interface QQ212, and/or any other component, or any combination thereof. Certain UEs may utilize all or a subset of the components shown in FIG. 2. The level of integration between the components may vary from one UE to another UE. Further, certain UEs may contain multiple instances of a component, such as multiple processors, memories, transceivers, transmitters, receivers, etc.

The processing circuitry QQ202 is configured to process instructions and data and may be configured to implement any sequential state machine operative to execute instructions stored as machine-readable computer programs in the memory QQ210. The processing circuitry QQ202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry QQ202 may include multiple central processing units (CPUs).

In the example, the input/output interface QQ206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE QQ200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source QQ208 is structured as a battery or battery pack. Other types of power sources, such as an external power source (e.g., an electricity outlet), photovoltaic device, or power cell, may be used. The power source QQ208 may further include power circuitry for delivering power from the power source QQ208 itself, and/or an external power source, to the various parts of the UE QQ200 via input circuitry or an interface such as an electrical power cable. Delivering power may be, for example, for charging of the power source QQ208. Power circuitry may perform any formatting, converting, or other modification to the power from the power source QQ208 to make the power suitable for the respective components of the UE QQ200 to which power is supplied.

The memory QQ210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory QQ210 includes one or more application programs QQ214, such as an operating system, web browser application, a widget, gadget engine, or other application, and corresponding data QQ216. The memory QQ210 may store, for use by the UE QQ200, any of a variety of various operating systems or combinations of operating systems.

The memory QQ210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory QQ210 may allow the UE QQ200 to access instructions, application programs and the like, stored on transitory or non-transitory memory media, to off-load data, or to upload data. An article of manufacture, such as one utilizing a communication system may be tangibly embodied as or in the memory QQ210, which may be or comprise a device-readable storage medium.

The processing circuitry QQ202 may be configured to communicate with an access network or other network using the communication interface QQ212. The communication interface QQ212 may comprise one or more communication subsystems and may include or be communicatively coupled to an antenna QQ222. The communication interface QQ212 may include one or more transceivers used to communicate, such as by communicating with one or more remote transceivers of another device capable of wireless communication (e.g., another UE or a network node in an access network). Each transceiver may include a transmitter QQ218 and/or a receiver QQ220 appropriate to provide network communications (e.g., optical, electrical, frequency allocations, and so forth). Moreover, the transmitter QQ218 and receiver QQ220 may be coupled to one or more antennas (e.g., antenna QQ222) and may share circuit components, software or firmware, or alternatively be implemented separately.

In the illustrated embodiment, communication functions of the communication interface QQ212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface QQ212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE QQ200 shown in FIG. 2.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 3 shows a network node QQ300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)), O-RAN nodes or components of an O-RAN node (e.g., O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units, distributed units (e.g., in an O-RAN access node) and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node QQ300 includes a processing circuitry QQ302, a memory QQ304, a communication interface QQ306, and a power source QQ308. The network node QQ300 may be composed of multiple physically separate components (e.g., a NodeB component and a RNC component, or a BTS component and a BSC component, etc.), which may each have their own respective components. In certain scenarios in which the network node QQ300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node QQ300 may be configured to support multiple radio access technologies (RATs). In such embodiments, some components may be duplicated (e.g., separate memory QQ304 for different RATs) and some components may be reused (e.g., a same antenna QQ310 may be shared by different RATs). The network node QQ300 may also include multiple sets of the various illustrated components for different wireless technologies integrated into network node QQ300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node QQ300.

The processing circuitry QQ302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node QQ300 components, such as the memory QQ304, to provide network node QQ300 functionality.

In some embodiments, the processing circuitry QQ302 includes a system on a chip (SOC). In some embodiments, the processing circuitry QQ302 includes one or more of radio frequency (RF) transceiver circuitry QQ312 and baseband processing circuitry QQ314. In some embodiments, the radio frequency (RF) transceiver circuitry QQ312 and the baseband processing circuitry QQ314 may be on separate chips (or sets of chips), boards, or units, such as radio units and digital units. In alternative embodiments, part or all of RF transceiver circuitry QQ312 and baseband processing circuitry QQ314 may be on the same chip or set of chips, boards, or units.

The memory QQ304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry QQ302. The memory QQ304 may store any suitable instructions, data, or information, including a computer program, software, an application including one or more of logic, rules, code, tables, and/or other instructions capable of being executed by the processing circuitry QQ302 and utilized by the network node QQ300. The memory QQ304 may be used to store any calculations made by the processing circuitry QQ302 and/or any data received via the communication interface QQ306. In some embodiments, the processing circuitry QQ302 and memory QQ304 is integrated.

The communication interface QQ306 is used in wired or wireless communication of signaling and/or data between a network node, access network, and/or UE. As illustrated, the communication interface QQ306 comprises port(s)/terminal(s) QQ316 to send and receive data, for example to and from a network over a wired connection. The communication interface QQ306 also includes radio front-end circuitry QQ318 that may be coupled to, or in certain embodiments a part of, the antenna QQ310. Radio front-end circuitry QQ318 comprises filters QQ320 and amplifiers QQ322. The radio front-end circuitry QQ318 may be connected to an antenna QQ310 and processing circuitry QQ302. The radio front-end circuitry may be configured to condition signals communicated between antenna QQ310 and processing circuitry QQ302. The radio front-end circuitry QQ318 may receive digital data that is to be sent out to other network nodes or UEs via a wireless connection. The radio front-end circuitry QQ318 may convert the digital data into a radio signal having the appropriate channel and bandwidth parameters using a combination of filters QQ320 and/or amplifiers QQ322. The radio signal may then be transmitted via the antenna QQ310. Similarly, when receiving data, the antenna QQ310 may collect radio signals which are then converted into digital data by the radio front-end circuitry QQ318. The digital data may be passed to the processing circuitry QQ302. In other embodiments, the communication interface may comprise different components and/or different combinations of components.

In certain alternative embodiments, the network node QQ300 does not include separate radio front-end circuitry QQ318, instead, the processing circuitry QQ302 includes radio front-end circuitry and is connected to the antenna QQ310. Similarly, in some embodiments, all or some of the RF transceiver circuitry QQ312 is part of the communication interface QQ306. In still other embodiments, the communication interface QQ306 includes one or more ports or terminals QQ316, the radio front-end circuitry QQ318, and the RF transceiver circuitry QQ312, as part of a radio unit (not shown), and the communication interface QQ306 communicates with the baseband processing circuitry QQ314, which is part of a digital unit (not shown).

The antenna QQ310 may include one or more antennas, or antenna arrays, configured to send and/or receive wireless signals. The antenna QQ310 may be coupled to the radio front-end circuitry QQ318 and may be any type of antenna capable of transmitting and receiving data and/or signals wirelessly. In certain embodiments, the antenna QQ310 is separate from the network node QQ300 and connectable to the network node QQ300 through an interface or port.

The antenna QQ310, communication interface QQ306, and/or the processing circuitry QQ302 may be configured to perform any receiving operations and/or certain obtaining operations described herein as being performed by the network node. Any information, data and/or signals may be received from a UE, another network node and/or any other network equipment. Similarly, the antenna QQ310, the communication interface QQ306, and/or the processing circuitry QQ302 may be configured to perform any transmitting operations described herein as being performed by the network node. Any information, data and/or signals may be transmitted to a UE, another network node and/or any other network equipment.

The power source QQ308 provides power to the various components of network node QQ300 in a form suitable for the respective components (e.g., at a voltage and current level needed for each respective component). The power source QQ308 may further comprise, or be coupled to, power management circuitry to supply the components of the network node QQ300 with power for performing the functionality described herein. For example, the network node QQ300 may be connectable to an external power source (e.g., the power grid, an electricity outlet) via an input circuitry or interface such as an electrical cable, whereby the external power source supplies power to power circuitry of the power source QQ308. As a further example, the power source QQ308 may comprise a source of power in the form of a battery or battery pack which is connected to, or integrated in, power circuitry. The battery may provide backup power should the external power source fail.

Embodiments of the network node QQ300 may include additional components beyond those shown in FIG. 3 for providing certain aspects of the network node's functionality, including any of the functionality described herein and/or any functionality necessary to support the subject matter described herein. For example, the network node QQ300 may include user interface equipment to allow input of information into the network node QQ300 and to allow output of information from the network node QQ300. This may allow a user to perform diagnostic, maintenance, repair, and other administrative functions for the network node QQ300.

FIG. 4 is a block diagram of a host QQ400, which may be an embodiment of the host QQ116 of FIG. 1, in accordance with various aspects described herein. As used herein, the host QQ400 may be or comprise various combinations hardware and/or software, including a standalone server, a blade server, a cloud-implemented server, a distributed server, a virtual machine, container, or processing resources in a server farm. The host QQ400 may provide one or more services to one or more UEs.

The host QQ400 includes processing circuitry QQ402 that is operatively coupled via a bus QQ404 to an input/output interface QQ406, a network interface QQ408, a power source QQ410, and a memory QQ412. Other components may be included in other embodiments. Features of these components may be substantially similar to those described with respect to the devices of previous figures, such as FIGS. 2 and 3, such that the descriptions thereof are generally applicable to the corresponding components of host QQ400.

The memory QQ412 may include one or more computer programs including one or more host application programs QQ414 and data QQ416, which may include user data, e.g., data generated by a UE for the host QQ400 or data generated by the host QQ400 for a UE. Embodiments of the host QQ400 may utilize only a subset or all of the components shown. The host application programs QQ414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs QQ414 may also provide for user authentication and licensing checks and may periodically report health, routes, and content availability to a central node, such as a device in or on the edge of a core network. Accordingly, the host QQ400 may select and/or indicate a different host for over-the-top services for a UE. The host application programs QQ414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 5 is a block diagram illustrating a virtualization environment QQ500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments QQ500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized. In some embodiments, the virtualization environment QQ500 includes components defined by the O-RAN Alliance, such as an O-Cloud environment orchestrated by a Service Management and Orchestration Framework via an O-2 interface.

Applications QQ502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware QQ504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers QQ506 (also referred to as hypervisors or virtual machine monitors (VMMs)), provide VMs QQ508a and QQ508b (one or more of which may be generally referred to as VMs QQ508), and/or perform any of the functions, features and/or benefits described in relation with some embodiments described herein. The virtualization layer QQ506 may present a virtual operating platform that appears like networking hardware to the VMs QQ508.

The VMs QQ508 comprise virtual processing, virtual memory, virtual networking or interface and virtual storage, and may be run by a corresponding virtualization layer QQ506. Different embodiments of the instance of a virtual appliance QQ502 may be implemented on one or more of VMs QQ508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment. In the context of NFV, a VM QQ508 may be a software implementation of a physical machine that runs programs as if they were executing on a physical, non-virtualized machine. Each of the VMs QQ508, and that part of hardware QQ504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs QQ508 on top of the hardware QQ504 and corresponds to the application QQ502.

Hardware QQ504 may be implemented in a standalone network node with generic or specific components. Hardware QQ504 may implement some functions via virtualization. Alternatively, hardware QQ504 may be part of a larger cluster of hardware (e.g. such as in a data center or CPE) where many hardware nodes work together and are managed via management and orchestration QQ510, which, among others, oversees lifecycle management of applications QQ502. In some embodiments, hardware QQ504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system QQ512 which may alternatively be used for communication between hardware nodes and radio units.

FIG. 6 shows a communication diagram of a host QQ602 communicating via a network node QQ604 with a UE QQ606 over a partially wireless connection in accordance with some embodiments. Example implementations, in accordance with various embodiments, of the UE (such as a UE QQ112a of FIG. 1 and/or UE QQ200 of FIG. 2), network node (such as network node QQ110a of FIG. 1 and/or network node QQ300 of FIG. 3), and host (such as host QQ116 of FIG. 1 and/or host QQ400 of FIG. 4) discussed in the preceding paragraphs will now be described with reference to FIG. 6.

Like host QQ400, embodiments of host QQ602 include hardware, such as a communication interface, processing circuitry, and memory. The host QQ602 also includes software, which is stored in or accessible by the host QQ602 and executable by the processing circuitry. The software includes a host application that may be operable to provide a service to a remote user, such as the UE QQ606 connecting via an over-the-top (OTT) connection QQ650 extending between the UE QQ606 and host QQ602. In providing the service to the remote user, a host application may provide user data which is transmitted using the OTT connection QQ650.

The network node QQ604 includes hardware enabling it to communicate with the host QQ602 and UE QQ606. The connection QQ660 may be direct or pass through a core network (like core network QQ106 of FIG. 1) and/or one or more other intermediate networks, such as one or more public, private, or hosted networks. For example, an intermediate network may be a backbone network or the Internet.

The UE QQ606 includes hardware and software, which is stored in or accessible by UE QQ606 and executable by the UE's processing circuitry. The software includes a client application, such as a web browser or operator-specific “app” that may be operable to provide a service to a human or non-human user via UE QQ606 with the support of the host QQ602. In the host QQ602, an executing host application may communicate with the executing client application via the OTT connection QQ650 terminating at the UE QQ606 and host QQ602. In providing the service to the user, the UE's client application may receive request data from the host's host application and provide user data in response to the request data. The OTT connection QQ650 may transfer both the request data and the user data. The UE's client application may interact with the user to generate the user data that it provides to the host application through the OTT connection QQ650.

The OTT connection QQ650 may extend via a connection QQ660 between the host QQ602 and the network node QQ604 and via a wireless connection QQ670 between the network node QQ604 and the UE QQ606 to provide the connection between the host QQ602 and the UE QQ606. The connection QQ660 and wireless connection QQ670, over which the OTT connection QQ650 may be provided, have been drawn abstractly to illustrate the communication between the host QQ602 and the UE QQ606 via the network node QQ604, without explicit reference to any intermediary devices and the precise routing of messages via these devices.

As an example of transmitting data via the OTT connection QQ650, in step QQ608, the host QQ602 provides user data, which may be performed by executing a host application. In some embodiments, the user data is associated with a particular human user interacting with the UE QQ606. In other embodiments, the user data is associated with a UE QQ606 that shares data with the host QQ602 without explicit human interaction. In step QQ610, the host QQ602 initiates a transmission carrying the user data towards the UE QQ606. The host QQ602 may initiate the transmission responsive to a request transmitted by the UE QQ606. The request may be caused by human interaction with the UE QQ606 or by operation of the client application executing on the UE QQ606. The transmission may pass via the network node QQ604, in accordance with the teachings of the embodiments described throughout this disclosure. Accordingly, in step QQ612, the network node QQ604 transmits to the UE QQ606 the user data that was carried in the transmission that the host QQ602 initiated, in accordance with the teachings of the embodiments described throughout this disclosure. In step QQ614, the UE QQ606 receives the user data carried in the transmission, which may be performed by a client application executed on the UE QQ606 associated with the host application executed by the host QQ602.

In some examples, the UE QQ606 executes a client application which provides user data to the host QQ602. The user data may be provided in reaction or response to the data received from the host QQ602. Accordingly, in step QQ616, the UE QQ606 may provide user data, which may be performed by executing the client application. In providing the user data, the client application may further consider user input received from the user via an input/output interface of the UE QQ606. Regardless of the specific manner in which the user data was provided, the UE QQ606 initiates, in step QQ618, transmission of the user data towards the host QQ602 via the network node QQ604. In step QQ620, in accordance with the teachings of the embodiments described throughout this disclosure, the network node QQ604 receives user data from the UE QQ606 and initiates transmission of the received user data towards the host QQ602. In step QQ622, the host QQ602 receives the user data carried in the transmission initiated by the UE QQ606.

One or more of the various embodiments improve the performance of OTT services provided to the UE QQ606 using the OTT connection QQ650, in which the wireless connection QQ670 forms the last segment. More precisely, the teachings of these embodiments may improve the flexibility, efficiency and/or power consumption and thereby provide benefits such as e.g., reduced user wait time, more flexible setup, extended battery lifetime, improved content resolution, and/or improved scalability.

In an example scenario, factory status information may be collected and analyzed by the host QQ602. As another example, the host QQ602 may process audio and video data which may have been retrieved from a UE for use in creating maps. As another example, the host QQ602 may collect and analyze real-time data to assist in controlling vehicle congestion (e.g., controlling traffic lights). As another example, the host QQ602 may store surveillance video uploaded by a UE. As another example, the host QQ602 may store or control access to media content such as video, audio, VR or AR which it can broadcast, multicast or unicast to UEs. As other examples, the host QQ602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection QQ650 between the host QQ602 and UE QQ606, in response to variations in the measurement results. The measurement procedure and/or the network functionality for reconfiguring the OTT connection may be implemented in software and hardware of the host QQ602 and/or UE QQ606. In some embodiments, sensors (not shown) may be deployed in or in association with other devices through which the OTT connection QQ650 passes; the sensors may participate in the measurement procedure by supplying values of the monitored quantities exemplified above, or supplying values of other physical quantities from which software may compute or estimate the monitored quantities. The reconfiguring of the OTT connection QQ650 may include message format, retransmission settings, preferred routing etc.; the reconfiguring need not directly alter the operation of the network node QQ604. Such procedures and functionalities may be known and practiced in the art. In certain embodiments, measurements may involve proprietary UE signaling that facilitates measurements of throughput, propagation times, latency and the like, by the host QQ602. The measurements may be implemented in that software causes messages to be transmitted, in particular empty or ‘dummy’ messages, using the OTT connection QQ650 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

When using the word “comprise” or “comprising” it shall be interpreted as non-limiting, i.e. meaning “consist at least of”.

The embodiments herein are not limited to the preferred embodiments described above. Various alternatives, modifications and equivalents may be used.

The below table may define any abbreviation used above or in embodiments herein.

| Abbreviation | Explanation |
|---|---|
| NaaS | Network-as-a-Service |
| PDN | Packet Data Network |
| QoD | QoS on Demand |
| QoS | Quality of Service |

1. A method performed by a network node for managing an Internet Protocol, IP, flow in a User Plane, UP, session to be boosted on request by an Application Function, AF, node for a User Equipment, UE, in a wireless communications network, the method comprising:
obtaining from a first Core Network, CN, node, information identifying UP sessions that are available to the UE, based on a subscriber identifier of a user of the UE, and
determining, based on configuration data received from a second CN node, whether boost is allowed for a particular UP session among the identified UP sessions,
when it is determined that boost is allowed in the particular UP session, determining a source IP address for the particular UP session,
requesting from the second CN node, boost of the IP flow identified by the source IP address as determined, and a destination IP address and port comprised in information obtained from the AF node, and
configuring in the second CN node, a Policy and Charging Control, PCC, rule to the identified IP flow for the particular UP session where boost is determined to be allowed.

2. The method according to claim 1 further comprising receiving a request for the IP flow to be boosted, as transmitted by the AF node 130 to the network node 141.

3. The method according to claim 1, wherein,
determining whether boost is allowed for the particular UP session out of the identified UP sessions comprises determining whether boost is allowed for multiple UP sessions out of the identified UP sessions, and
wherein configuring in the second CN node, the PCC rule to the identified IP flow for the particular UP session when the boost is determined to be allowed comprises configuring in the second CN node, a PCC rule to the IP flow for each respective UP session out of the multiple UP sessions where boost is determined to be allowed.

4. The method according to claim 1, wherein, requesting the boost of the IP flow and/or configuring the PCC rule to the identified IP flow for the particular UP session is performed in response to detecting the IP flow in the particular UP session.

5. The method according to claim 1, further comprising:
removing a PCC rule from UP sessions where boost is determined to be allowed but which are not comprising the particular IP flow.

6. The method according to claim 1, wherein the network node is represented by any one or more out of a Network Exposure Function, NEF, a Service Capability Exposure Function, SCEF, or a Network as a Service, NaaS.

7. The method according to claim 1, wherein the first CN node is represented by a Home Subscriber Server, HSS, or a Unified Data Management, UDM, or other network entity.

8. The method according to claim 1, wherein the second CN node is represented by any one out of a Unified Data Management, UDM, Policy Control Function, PCF, Policy and Charging Rules Function, PCRF, or other entity.

9. The method according to claim 1, wherein the UP session is represented by any one out of: a Packet Data Network, PDU, session or a Packet Data Network, PDN, connectivity, and which UP session is a user plane connectivity in a wireless data network associated with the wireless communications network.

10. A computer program product comprising instructions, which when executed by a processor, causes the processor to perform actions according to claim 1.

11. (canceled)

12. A network node, configured to manage an Internet Protocol, IP, flow in a User Plane, UP, session to be boosted on request by an Application Function, AF, node for a User Equipment, UE, in a wireless communications network, the network node further being configured to:
obtain from a first Core Network, CN, node information identifying UP sessions that are available to the UE, based on a subscriber identifier of a user of the UE,
determine whether boost is allowed for a particular UP session among the identified UP sessions, based on configuration data received from a second CN node,
when it is determined that boost is allowed in the particular UP session, determine a source IP address for the particular UP session,
request from the second CN node, a boost of the IP flow identified by the source IP address as determined, and a destination IP address and port comprised in information obtained from the AF node, and
configure in the second CN node, a Policy and Charging Control, PCC, rule to the identified IP flow for the particular UP session where boost is determined to be allowed.

13. The network node according to claim 12, wherein,
determine whether boost is allowed for a particular UP session out of the identified UP sessions by determining whether boost is allowed for multiple UP sessions out of the identified UP sessions, and
configure in the second CN node, a PCC rule to the identified IP flow for the particular UP session when boost is determined to be allowed by configuring in the second CN node, a PCC rule to the IP flow for each respective UP session out of the multiple UP sessions where boost is determined to be allowed.

14. The network node according to claim 12, wherein, requesting the boost of the IP flow and/or configuring the PCC rule to the identified IP flow for the particular UP session is performed in response to detecting the IP flow in the particular UP session.

15. The network node according to claim 12 further configured to receive a request for the IP flow to be boosted, as transmitted by the AF node 130 to the network node 141.

16. The network node according to claim 12, further configured to:
remove a PCC rule from UP sessions where boost is determined to be allowed but which are not comprising the particular IP flow.

17. The network node according to claim 12, wherein any one or more out of:
the network node is adapted to be represented by any one or more out of a Network Exposure Function, NEF, a Service Capability Exposure Function, SCEF, or a Network as a Service, Naas,
the first CN node is adapted to be represented by a Home Subscriber Server, HSS, or a Unified Data Management, UDM, or other entity, and
the second CN node is adapted to be represented by any one out of a Unified Data Management, UDM, Policy Control Function, PCF, Policy and Charging Rules Function, PCRF, or other entity.

18. The network node according to claim 12, wherein the UP session is adapted to be represented by any one out of: a Packet Data Network, PDU, session or a Packet Data Network, PDN, connectivity, and which UP session is adapted to be a user plane connectivity in a wireless data network associated with the wireless communications network.
